(19) United States
(12) Patent Application Publication
(10) Pub. No.: US 2007/0022202 A1
(43) Pub. Date: Jan. 25, 2007

(54) System and method for deactivating web pages

(76) Inventors: Karyn S. Finkle, Park Ridge, NJ (US); Thomas L. Lee, Grayslake, IL (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/491,213

(22) Filed: Jul. 21, 2006

Related U.S. Application Data
(60) Provisional application No. 60/701,708, filed on Jul. 22, 2005.

(51) Int. Cl. G06F 15/16

(52) U.S. Cl. 709/227; 709/217

(57) ABSTRACT

A method for deactivating a web page, including installing at least one browser helper object on a web browser, instantiating at least one data manager by activating the web browser, providing at least one keyword list to the at least one data manager, directing the at least one web browser to at least one URL, the URL having a web page with content associated therewith, comparing the content of the at least one web page with the at least one keyword list, and deactivating the web page upon find at least one matching stimulus corresponding to at least one item on the key word list.

### CROSS-REFERENCE TO RELATED APPLICATION

This application claims the benefit of U.S. Provisional Patent Application No. 60/701,708, filed Jul. 22, 2005, the entire disclosure of which is hereby incorporated herein by reference.

### FIELD OF THE INVENTION

The present invention relates generally to a methods for blocking the submission of data via the Internet and for blocking access to pornographic, gambling-oriented and other harmful content.

### BACKGROUND OF THE INVENTION

Identity theft is a major concern among Internet users. Various schemes for acquiring personal information are employed to obtain social security numbers, credit card numbers, and a host of other items of information. Those obtaining the information may use it to make credit card purchases, obtain privileges and engage in otherwise impossible activity, causing damage to the finances, personal reputations and credit ratings of others.

One common method of obtaining sensitive information is known as “phishing.” In computing, phishing is a form of criminal activity conducted by using social engineering techniques. Social engineering is the practice of obtaining confidential information by manipulation of legitimate users. A social engineer will commonly use Internet to trick people into revealing sensitive information or getting them to do something that is against typical policies. By this method, social engineers exploit the natural tendency of a person to trust his or her word, rather than exploiting computer security holes. It is generally agreed upon that “users are the weak link” in security and this principle is what makes social engineering possible.

Thus, phishing is characterized by attempts to fraudulently acquire sensitive information, such as passwords and credit card details, by masquerading as a trustworthy person or business in an apparently official electronic communication. Phishing is typically carried out using an email or instant message in order to lead a person to enter information onto a website. The term “phishing” derives from “password harvesting” and the use of increasingly sophisticated lures to “fish” for users' financial information and passwords.

With the growing number of reported phishing incidents, additional methods of protection are needed. Attempts, including legislation, user training, and technical measures have been generally unsuccessful.

More recent phishing attempts have targeting the customers of banks and online payment services. E-mails appearing to come from the Internal Revenue Service have also been used to glean sensitive data from U.S. taxpayers. While the first of such attempts were made indiscriminately in the hope of finding a customer of a given bank or service, recent research has shown that phishers may in principle be able to determine what bank a potential victim has a relationship with, and then send an appropriate spoofed email to the victim. In general such targeted versions of phishing have been termed “spear phishing.” Social networking sites are also a target of phishing, since the personal details in such sites can be used in identity theft. Recent experiments show a success rate of over 70% for phishing attacks on social networks.

Most methods of phishing apply some form of technical deception designed to make a link in an email appear to belong to the spoofed organization. Misspelled Uniform Resource Locators (“URLs”) or the use of subdomains are common tricks used by phishers.

Some phishing scams use javascript commands in order to alter the address bar. This is done either by placing a picture of the legitimate entity's URL over the address bar, or by closing the original address bar and opening a new one containing the legitimate URL.

In another popular method of phishing, an attacker uses a bank or service's own scripts against the victim. These types of attacks “known as cross-site scripting” are particularly problematic, because they direct the user to sign in at their bank or service's own web page, where everything from the web address to the security certificates appears correct. In reality, the link to the website is crafted to carry out the attack, and it is very difficult to spot without specialist knowledge. Just such a method was used in early 2006 against PayPal.

A further problem with URLs has been found in the handling of Internationalized domain names (IDN) in web browsers, that might allow visually identical web addresses to lead to different, possibly malicious, websites.

The damage caused by phishing ranges from loss of access to email to substantial financial loss. This style of identity theft is becoming more popular, because of the ease with which unsuspecting people often divulge personal information to phishers, including credit card numbers and social security numbers. Once this information is acquired, the phishers may use an individual's personal information to create fake accounts in a victim's name, ruin a victim's credit, or even prevent the victim from accessing his/her own account.

It is estimated that between May 2004 and May 2005, approximately 1.2 million computer users in the United States suffered losses caused by phishing, totaling approximately $929 million. U.S. businesses lose an estimated $2 billion a year as their clients become victims.

Further, studies indicate that the number of phishing incidents is increasing at an alarming rate. A recent report by the Anti-Phishing Working Group (“APWG”) found that phishing attacks have increased by an average of 30% each month since July 2004. In January 2005, alone, more than 12,800 phishing emails and 2,560 phishing web sites, representing 64 hijacked brands, were reported and tracked by the APWG. Perhaps the rapid growth of this new type of consumer fraud can be explained by the additional finding by the APWG that “data suggests that phishers are able to convince up to 5% of recipients to respond to them.” By contrast, the estimated response rate for regular spam is 0.01%.

Internet use in general and phishing in particular present particular problems for parents of children who are tempted to submit personal information and/or make unauthorized purchases over the Internet. As parents continue to work longer hours and it becomes increasingly impractical to exercise direct, consistent control over their children and teenagers, the risk that children and teenagers will submit personal information and/or make unauthorized purchases over the Internet increases.

Similarly, there is a risk that children will access pornographic and other harmful content on the Internet, including gambling-oriented content.

Thus, there is a need for an improved method and system for preventing children from accessing certain cites on the Internet.

### SUMMARY OF THE INVENTION

Embodiments of the present invention satisfy this and other needs by providing a system and method for blocking the submission of data via the Internet and for blocking access to pornographic, gambling-oriented and other harmful content.

Embodiments of the present invention include a method for deactivating a web page, including installing at least one browser helper object on a web browser, instantiating at least one data manager by activating the web browser, providing at least one keyword list to the at least one data manager, directing the at least one web browser to at least one URL, the URL having a web page with content associated therewith, comparing the content of the at least one web page with the at least one keyword list, and deactivating the web page upon find at least one matching stimulus corresponding to at least one item on the key word list.

Thus, embodiments of the present invention provide an improved method and system for blocking the submission of personal data via the Internet and for blocking access to violent, pornographic, gambling-oriented and other harmful content.

### BRIEF DESCRIPTION OF THE DRAWINGS

The present invention will be more readily understood from the detailed description of exemplary embodiments presented below considered in conjunction with the attached drawings, of which:

FIG. 1 illustrates a process by which a web page is deactivated;

FIG. 2. illustrates the use of the system tray application of the present invention; and

FIG. 3 illustrates a process for the integration of the deactivation and system tray application function.

It is to be understood that the attached drawings are for purposes of illustrating the concepts of the invention.

### DETAILED DESCRIPTION OF THE INVENTION

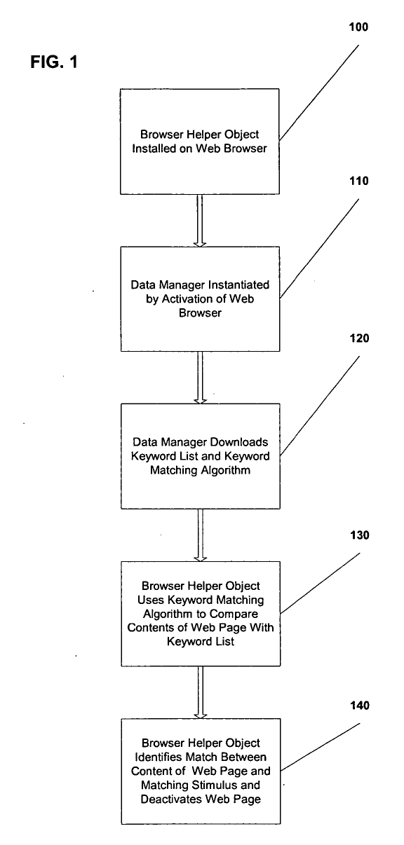

With reference to FIG. 1, a browser helper object is installed on a web browser in step 100. The browser helper object may be downloaded via the Internet, compact disc or other medium. As it is used herein, the term “browser helper object” is intended to include, but is not limited to, a programming unit added to a web browser in order to allow the web browser to perform a new function. Next, in step 110, the web browser having the browser helper object installed on it is activated by a user, thus instantiating a data manager. The web browser may be activated any means known to those of skill in the art. As it is used herein, the term “instantiate” is intended to include, but is not limited to, creating an individual programming unit which will serve as a basic building block for a process. As it is used herein, the term “data manager,” is a local server process. Local server processes are known to those of skill in the art.

Next, in step 120, the data manager downloads a keyword list and keyword matching algorithm via the Internet, compact disc or other medium. According to embodiments of the present invention, the keyword list is downloaded initially and then downloaded every 24 hours. Thus, the keyword list can be updated by a server with new content, so the data manager will update the list every 24 hours. According to embodiments of the present invention, a user with administrative, password-protected privileges may create his/her own keyword list. The data manager would possess the capability of generating a keyword matching algorithm. As used herein, the term “keyword list” is intended to include, but is not limited to, a list of terms that are associated with the solicitation of personal information or with undesirable content. For example, personal information includes, but is not limited to name, address, phone number, credit card number, debit card number and checking account number. Undesirable content includes, but is not limited to, violent or sexually explicit pictures, video or text. As it used herein, the term “keyword matching algorithm” is intended to include, but is not limited to a procedure or finite set of well-defined instructions for identifying the presence on a web page of items listed on a keyword list.

Next, in step 130, the browser helper object uses the keyword matching algorithm to compare the contents of a web page with the keyword list.

Then, in step 140, the browser helper object identifies a match between the content of the web page and a matching stimulus, and deactivates the web page so that no information may be submitted via that web page. The browser helper object will mark all input fields “read-only” and disable the submit capability. Further, no information will be able to be entered into the flag fields. In the case of violent and pornographic websites, deactivation of the website would entail blocking the display of violent or sexually explicit pictures, video or text. As used herein, the term “matching stimulus” is intended to include, but is not limited to, a unit of content on a web page that corresponds to an item on a keyword list. The terms “input field” and “flag field” are known to those of skill in the art.

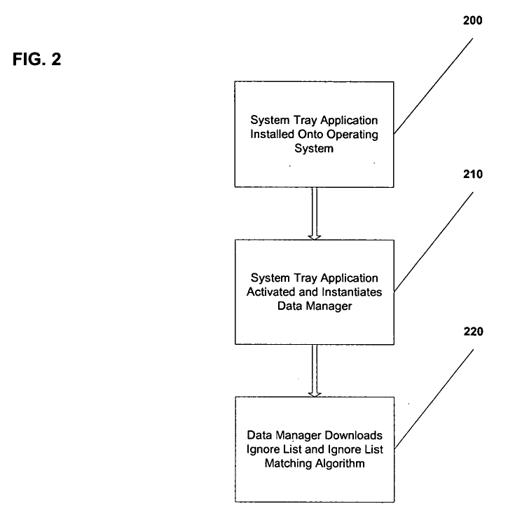

With reference to FIG. 2, a system tray application is installed onto an operating system in step 200. The system tray application may be downloaded from a compact disc or via the Internet from a remote server. Next, in step 210, the system tray application is activated by a user according to methods known to those of skill in the art, thus instantiating the data manager. Next, in step 220 the data manager downloads an ignore list and an ignore list matching algorithm. The ignore list may be downloaded via the Internet, compact disc or other medium. According to embodiments of the present invention, the user may create his/her own keyword list and the data manager would possess the capability of generating a keyword matching algorithm. In embodiments of the present invention, the ignore list may be established by the entity who develops and produces the embodiments of the present invention. Also, in embodiments of the present invention, the ignore list is generated by a system administrator through the system tray application. The criteria for URLs to be included on the ignore list are the URLs of established vendors of educational or other edifying material. The ignore list of an embodiment of the present invention may, for example, contain the URL of a website for purchasing school books or other educational material. As used herein the term, the term “ignore list” is intended to include, but is not limited to, a list of URLs whose pages will not be deactivated by the system, regardless of whether the pages contain matching stimuli as part of the process discussed in FIG. 1. As it used herein, the term “ignore list matching algorithm” is intended to include but is not limited to a procedure or finite set of well-defined instructions for identifying a URL that is not to be activated by the system.

In embodiments of the present invention, users of the system may add or delete URLs from the ignore list. In additional embodiments of the present invention, a user may create his/her own list. In further embodiments of the present invention, select users may be designated as administrators having password-protected privileges for adding and deleting URLs from the ignore list and for creating ignore lists.

Thus, for example, the proprietor of a violent, pornographic, and/or gambling website might purchase the domain name of a website that previously contained educational or other acceptable content. When a parent becomes of aware of this—by speaking with other parents or by other means—he/she may elect to remove this URL from the ignore list. Further, a parent may designate himself/herself as an administrator with password-protected privileges, thus preventing unauthorized children from adding URLs associated with violent, pornographic, and/or gambling websites to the ignore list.

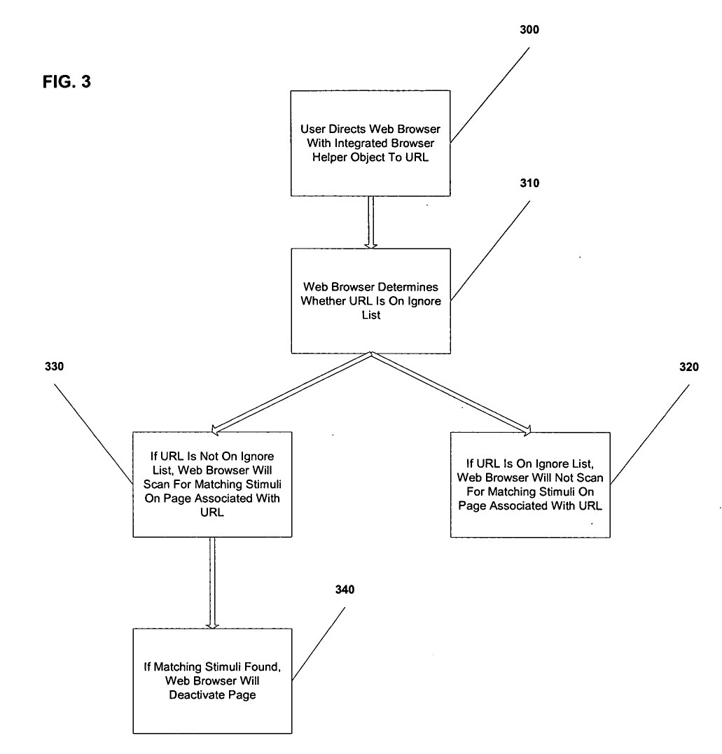

FIG. 3 illustrates an embodiment of the integration of the processes described with reference to FIG. 1 and FIG. 2. In step 300, a user directs a web browser with integrated browser helper object to a URL. In step 310, the web browser determines, with reference to the data manager, whether the URL to which the web browser has been directed is on the ignore list. If the URL is on the ignore list, then, in step 320, the web browser with integrated browser helper object will not scan for matching stimuli on the page associated with the URL. If the URL is not on the ignore list, then, in step 330, the web browser with integrated browser helper object will scan for matching stimuli on the page associated with the URL. If matching stimuli are found, then, in step 340, the browser helper object will deactivate the page.

In embodiments of the present invention, the data manager is a singleton object. That is, once a data manager is instantiated by a first browser helper object and associated web browser, new data managers are not instantiated when additional web browsers are activated by a user. Rather, the data manager instantiated by the first browser helper object serves as a local server process for all web browsers that are subsequently opened during an operating system use session. Thus, in these embodiments, the web browsers function as clients. The terms “singleton object,” “local server process” and “client” are terms known to those of skill in the art.

In further embodiments of the present invention, the data manager will generate hash tables corresponding to keyword lists and ignore lists. As used herein, the term “hash table” is intended to include but is not limited to a data structure intended to increase look-up speed and efficiency. The use of has tables is known to those of skill in the art.

In embodiments of the present invention, the items on the keyword list are HTML input element titles. As used herein, the term “HTML input element title” is intended to include, but is not limited to, text that is commonly found on web pages containing forms intended to be populated and submitted. Common HTML input element titles include, but are not limited to the following terms: “name,” “first,” “last,” “address,” “phone,” “phone number,” “email,” “e-mail,” “company,” “city,” “state,” “zip,” “area code,” “required,” “billing address,” “shipping address,” “credit card,” “CC,” “Visa,” “MasterCard,” “American Express,” “Discover,” and “Diner's Club.”

In these embodiments, the data manager generates a hash table corresponding to a list of HTML input element titles. Further, the data manager generates an HTML input element title algorithm and uses it to identify whether the HTML element titles listed on a hash table are present on a web page. As it used herein, the term “HTML input element title matching algorithm” is intended to include but is not limited to a procedure or finite set of well-defined instructions for identifying the presence of items listed on an HTML input element title list.

In further embodiments of the present invention, the items on the keyword list are submit button noun names. As used herein, the term “submit button noun names” is intended to include, but is not limited to, text that is commonly found on web pages associated with buttons which users select or click on in order to submit data via the Internet or other media. In these embodiments, the data manager generates a hash table corresponding to a list of submit button noun names. Further, the data manager generates a submit button noun name algorithm and uses it to identify whether submit button noun names listed on the hash table are present on a web page. As it used herein, the term “submit button noun name matching algorithm” is intended to include but is not limited to a procedure or finite set of well-defined instructions for identifying the presence of items listed on a submit button noun name list.

Thus, embodiments of the present invention provide a means for combating the success of phishing attempts by deactivating pages calling for submission of personal information. Embodiments of the present invention also block access by children to violent, pornographic, gambling-oriented and other harmful content.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A method for deactivating a web page, comprising
installing at least one browser helper object on a web browser;
instantiating at least one data manager by activating the web browser;
providing at least one keyword list to the at least one data manager;
directing the at least one web browser to at least one URL, the URL having a web page with content associated therewith;
comparing the content of the at least one web page with the at least one keyword list; and
deactivating the web page upon find at least one matching stimulus corresponding to the at least one item on the key word list.

2. The method of claim 1, wherein the content is compared by scanning by the web browser of the content of the web page.

3. The method of claim 1, wherein the data manager generates a hash table for the keyword list.

4. The method of claim 3, wherein the hash table is accessed by the web browser by means of a keyword list matching algorithm.

5. The method of claim 1, wherein the at least one matching stimulus is at least one HTML input element title.

6. The method of claim 5, wherein the data manager generates a hash table for the at least one HTML input element title.

7. The method of claim 6, wherein the hash table is accessed by the browser helper object by means of an HTML input element title matching algorithm.

8. The method of claim 1, wherein a user may control whether a web page containing a matching stimulus is deactivated.

9. The method of claim 8, wherein a user may exercise said control by means of a system tray application.

10. The method of claim 9, wherein the user may use the system tray application to generate an ignore list on the data manager, the ignore list containing a series of URLs whose web pages will not be deactivated.

11. The method of claim 10, wherein the user may add or delete items from the ignore list.

12. The method of claim 11, wherein users may be designated as administrators having password-protected privileges for adding and deleting URLs from the ignore list and for creating ignore lists.

13. The method of claim 10, wherein the data manager generates a hash table for the ignore list.

14. The method of claim 13, wherein the hash table is accessed by means of an ignore list matching algorithm.

15. A system for deactivating a web page, comprising
a web browser;
at least one browser helper object installed on the web browser;
at least one data manger instantiated by activating the web browser and capable of obtaining a keyword list; and
a keyword list located on the data manager for comparing with the content of the at least one web page and deactivating the at least one web page upon encountering at least one matching stimulus on the web page.

16. The system of claim 15, wherein the content is compared by scanning by the web browser of the content of the web page.

17. The system of claim 15, wherein the data manager generates a hash table for the keyword list.

18. The system of claim 17, wherein the hash table is accessed by the web browser by means of a keyword list matching algorithm.

19. The system of claim 15, wherein the at least one matching stimulus is at least one HTML input element title.

20. The system of claim 19, wherein the data manager generates a hash table for the at least one HTML input element title.

21. The system of claim 20, wherein the hash table is accessed by the browser helper object by means of an HTML input element title matching algorithm.

22. The system of claim 15, wherein a user may control whether a web page containing a matching stimulus is deactivated.

23. The system of claim 22, wherein a user may exercise said control by means of a system tray application.

24. The system of claim 23, wherein the user may use the system tray application to generate an ignore list on the data manager, the ignore list containing a series of URLs whose web pages will not be deactivated.

25. The system of claim 24, wherein the user may add or delete items from the ignore list.

26. The system of claim 25, wherein users may be designated as administrators having password-protected privileges for adding and deleting URLs from the ignore list and for creating ignore lists.

27. The system of claim 24, wherein the data manager generates a hash table for the ignore list.
